(19) United States
(12) Patent Application Publication
(10) Pub. No.: US 2023/0167715 A1
(43) Pub. Date: Jun. 1, 2023

(54) CARBON DIOXIDE SEQUESTRATION

(71) Applicant: Halliburton Energy Services, Inc., Houston, TX (US)

(72) Inventors: Hui ZHOU, Houston, TX (US); William Walter SHUMWAY, Houston, TX (US)

(21) Appl. No.: 17/537,640

(22) Filed: Nov. 30, 2021

(51) Int. Cl. E21B 41/00; E21B 33/10; C01F 11/18; C01F 5/24

(52) U.S. Cl. CPC E21B 41/0064; C01F 5/24; C01F 11/18; E21B 33/10

(57) ABSTRACT

A method including precipitating a precipitate including one or more divalent cation carbonates from a solution including the divalent cation of each of the one or more divalent cation carbonates, and storing at least a portion of the precipitate downhole by placing the at least the portion of the precipitate downhole via a well. Precipitating can include contacting the solution with a gas, such as atmospheric air, including carbon dioxide (CO₂). The method can further include separating the precipitate from the solution, and forming a slurry including the at least a portion of the precipitate. Placing the at least the portion of the precipitate downhole via the well can include pumping the slurry downhole via the well. A system is also provided. Via the system and method, CO₂ can be sequestered downhole.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present disclosure relates generally to systems and methods of sequestering carbon dioxide (CO₂). More specifically, this disclosure relates to precipitating carbonates by contacting an aqueous solution containing divalent cations with carbon dioxide (CO₂) in a gas including CO₂ under conditions at which a precipitate including one or more divalent metal cation carbonates forms, and introducing at least a portion of the precipitate downhole, whereby at least a portion of the precipitate is stored downhole.

### BACKGROUND

Natural resources (e.g., oil or gas) residing in a subterranean formation can be recovered by driving resources from the formation into a wellbore using, for example, a pressure gradient that exists between the formation and the wellbore, the force of gravity, displacement of the resources from the formation using a pump or the force of another fluid injected into the well or an adjacent well. A number of wellbore servicing fluids can be utilized during the formation and production from such wellbores. For example, in aspects, the production of fluid in the formation can be increased by hydraulically fracturing the formation. That is, a treatment fluid (e.g., a fracturing fluid) can be pumped down the wellbore to the formation at a rate and a pressure sufficient to form fractures that extend into the formation, providing additional pathways through which the oil or gas can flow to the well. Subsequently, oil or gas residing in the subterranean formation can be recovered or “produced” from the well by driving the fluid into the well. During production of the oil or gas, substantial quantities of produced water, which can contain high levels of total dissolved solids (TDS), and produced gas can also be produced from the well, and a variety of exhaust gases and flare gases conventionally sent to flare can be formed. For example, oil and gas wells produce oil, gas, and/or byproducts from subterranean formation hydrocarbon reservoirs. A variety of subterranean formation operations are utilized to obtain such hydrocarbons, such as drilling operations, completion operations, stimulation operations, production operations, enhanced recovery operations, and the like. Such subterranean formation operations typically use a large number of vehicles, heavy equipment, and other apparatus (collectively referred to as “machinery” herein) in order to achieve certain job requirements, such as treatment fluid pump rates. Such equipment may include, for example, pump trucks, sand trucks, cranes, conveyance equipment, mixing machinery, and the like. Many of these operations and machinery utilize combustion engines that produce exhaust gases (e.g., including carbon dioxide/greenhouse gas emissions) that are emitted into the atmosphere.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic flow diagram of a method, according to one or more embodiments of this disclosure;

FIG. 2 is a schematic flow diagram of precipitating a precipitate including one or more divalent cations from a solution including the divalent cation of each of the one or more divalent cation carbonates, according to one or more embodiments of the present disclosure;

FIG. 3 is a schematic of a method, according to one or more embodiments of the present disclosure;

FIG. 4 is a schematic of a system, according to one or more embodiments of the present disclosure, and

FIG. 5 is a schematic of a plurality of machinery that may be located and operated a wellsite for performing a subterranean formation operation and that may produce gas including CO₂, according to one or more embodiments of the present disclosure.

### DETAILED DESCRIPTION

It should be understood at the outset that although an illustrative implementation of one or more embodiments are provided below, the disclosed systems and/or methods can be implemented using any number of techniques, whether currently known or in existence. The disclosure should in no way be limited to the illustrative implementations, drawings, and techniques below, including the exemplary designs and implementations illustrated and described herein, but can be modified within the scope of the appended claims along with their full scope of equivalents.

A method of this disclosure will now be described with reference to FIG. 1, which is a schematic flow diagram of a method 100 according to one or more embodiments of this disclosure. As seen in FIG. 1, method 100 includes precipitating a precipitate including one or more divalent cation carbonates from a solution including a divalent cation of each of the one or more divalent cation carbonates at 110, and storing at least a portion of the precipitate downhole by placing the at least the portion of the precipitate downhole via a well at 120. The one or more divalent cation carbonates can include calcium carbonate (CaCO₃), magnesium carbonate (MgCO₃), or both CaCO₃ and MgCO₃, in which embodiments, the solution can include the divalent cation calcium (Ca²⁺), magnesium (Mg²⁺), or both Ca²⁺, and Mg²⁺, respectively.

As noted in FIG. 1, method 100 can further include separating the precipitate from the solution as depicted at 120, forming a slurry including the at least the portion of the precipitate, as depicted at 130, and/or plugging and abandoning the well as depicted at 150. In some such embodiments, placing the at least the portion of the precipitate downhole via the well at 120 includes pumping the slurry downhole via the well.

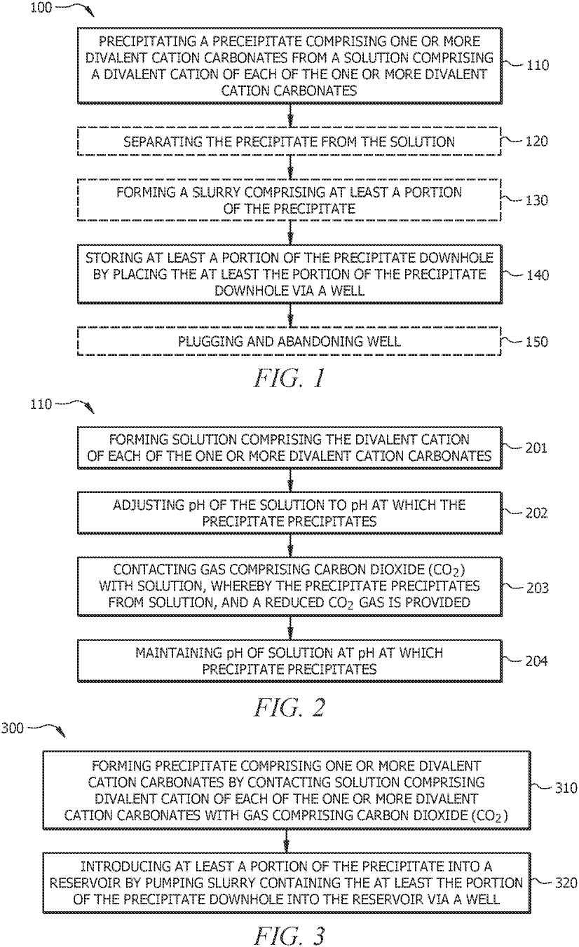

As depicted in FIG. 2, which is a schematic flow diagram of step 110 of precipitating the precipitate including one or more divalent cations from the solution including the divalent cation of each of the one or more divalent cation carbonates, according to one or more embodiments of the present disclosure, precipitating the precipitate can further include forming the solution including the divalent cation of each of the one or more divalent cation carbonates at 201, adjusting a pH of the solution to a pH at which the precipitate precipitates at 202, contacting a gas including carbon dioxide (CO₂) with the solution, at 203, whereby the precipitate precipitates from the solution, providing a reduced CO₂ gas, maintaining the pH of the solution at the pH at which the precipitate precipitates during the precipitating of the precipitate at 204, or a combination of one or more of 201 to 204. Although depicted in a certain order in FIG. 2, in embodiments, one or more of steps 201-204 can be absent, and/or the steps 201 to 204 can be performed more than once and/or in a different order than described herein or depicted in the embodiment of FIG. 2.

As depicted in FIG. 3, which is a schematic of a method 300, according to one or more embodiments of the present disclosure, a method 300 of this disclosure can include sequestering CO₂ by forming a precipitate including one or more divalent cation carbonates by contacting a solution including a divalent cation of each of the one or more divalent cation carbonates with a gas including CO₂, as depicted at 310, and introducing at least a portion of the precipitate into a reservoir by pumping a slurry including the at least the portion of the precipitate downhole into the reservoir via a well, as depicted at 320.

In embodiments, the gas including CO₂ includes air, and the method 100 can include, at precipitating step 110, passing air as the gas including CO₂ through a solution (and precipitation solution) including a divalent brine (e.g., calcium and/or magnesium) solution at a pH at which the one or more divalent cation carbonates (CaCO₃ or MgCO₃) precipitate from the precipitation solution as precipitate. The method 100 can further include, at step 120, separating the (CaCO₃ and/or MgCO₃) precipitate from the brine precipitation solution. The method 100 can further include, at step 130, slurrying (at least a portion of) the precipitate (e.g., the precipitated CaCO₃ and/or MgCO₃) into an appropriately pumpable WSF slurry. The method 100 can further include, at step 140, pumping the slurry down hole into a well suitable for the storage of the precipitate (e.g., the precipitated CaCO₃ or MgCO₃) and thereby deposit at least a portion of the precipitated CaCO₃ or MgCO₃ downhole (e.g., in a formation or reservoir). In embodiments, a depleted oil reservoir can be utilized as a suitable storage media. In embodiments, the method 100 can further include, at step 150, plugging and abandoning the well.

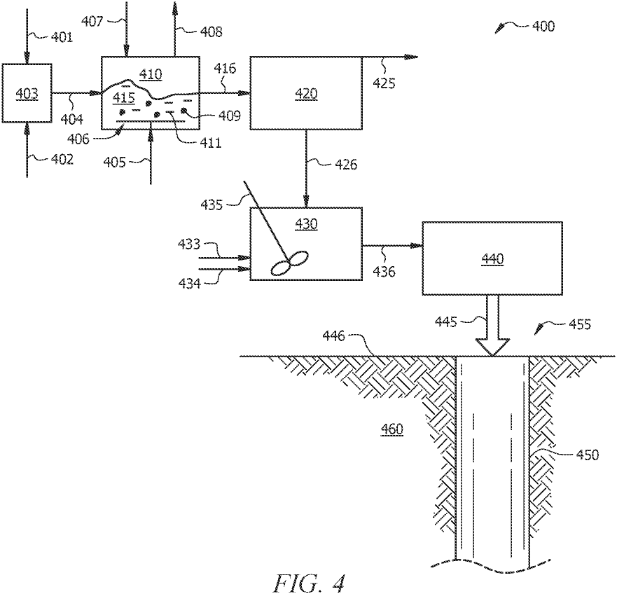

Although described herein with regard to storage of at least the portion of the precipitate downhole via a wellbore, the system and method described herein can also be utilized to store at least the portion of the precipitate underground (e.g., below a surface 446 (FIG. 4, described hereinbelow) of the earth) without utilizing a wellbore and/or above ground, without departing from the scope of this disclosure.

The method of this disclosure will now be detailed and a system for carrying out the method according to embodiments of this disclosure described with reference to FIG. 4, which is a schematic of a system 400, according to one or more embodiments of the present disclosure.

System 400 includes a precipitation apparatus 410 configured for contacting the solution 404 including one or more divalent cations with a gas including CO₂ 405 to precipitate a precipitate 409. The precipitate 409 can includes a carbonate of each of the one or more divalent cations in the solution 404. Contacting the gas including CO₂ 405 with the solution 404 can further include sparging via a sparger 406, or otherwise passing the gas including CO₂ 405 through precipitation solution 415 in precipitation apparatus 410. In embodiments, system 400 further includes a solution mixing apparatus 403 configured to contact water 401 with the one or more divalent cations 402 (e.g., a chloride salt of each of the one or more divalent cations) to form the solution 404. Although depicted as forming solution 404 prior to introduction into precipitation apparatus 410, water 401 and cations 402 can be separately introduced into precipitation apparatus 410, in some embodiments. Precipitation apparatus 410 can include an absorber, a bubbling apparatus, a sparger, or a combination thereof.

In embodiments, the gas including CO₂ 405 can include a produced gas, a flare gas, air, an exhaust gas, or a combination thereof, from the well 450 into which the at least the portion of the precipitate 409 is placed (further described hereinbelow) or another well. In embodiments, the gas including CO₂ 405 includes atmospheric air. In embodiments, the gas including CO₂ 405 includes a flare gas (e.g., a gas conventionally sent to flare), and the flare gas is contacted with the solution 404 in precipitation apparatus 410 to provide a reduced CO₂ gas 408 including a reduced CO₂ flare gas, flaring the reduced CO₂ flare gas 408 to produce a flared gas (a gas that has been passed through a gas combustion device (e.g. a flare)), and contacting the flared gas with solution 404 in precipitation reactor 410, to produce additional precipitate 409.

The solution 404 includes one or more divalent cations. In embodiments, the divalent cations are selected from calcium, magnesium, iron, strontium, or a combination thereof. For example, as noted above, the divalent cations can include calcium, magnesium, or a combination thereof, in which case the one or more carbonates of the precipitate can include calcium carbonate, magnesium carbonate, or a combination thereof respectively.

The solution 404 can include produced water, industrial waste water, seawater, brine, hard water, freshwater, tap water, city water, or a combination thereof. In aspects, cations 402 (e.g., materials including the cations) can be added to low total dissolved solids (TDS) waters 401 (e.g., water including less than about 200, 500, 1000, 1500, 2,000, 2500, 3000, 3500, 4000, 4500, or 5,000 ppm TDS), when such low TDS water is utilized to form solution 404. The produced water can be a product of a wellbore servicing operation of a well at the wellsite 455 or another wellsite including a well.

In aspects, solution 404 includes from about 10,000 to about 650,000 parts per million (ppm) (from about 1 to about 65 weight percent (wt%)), from about 100,000 to about 600,000 ppm (from about 10 to about 60 weight percent (wt%)), or from about 150,000 to about 600,000 ppm (from about 15 to about 60 weight percent (wt%)) TDS (e.g., divalent cations 402). In aspects, solution 404 includes greater than or equal to about 10,000, 20,000, 30,000, 40,000, 50,000, 60,000, 70,000, 80,000, 90,000, 100,000, 150,000, 200,000, 250,000, 300,000, 350,000, 400,000, 450,000, 500,000, 550,000, or 600,000 ppm (greater than or equal to about 1, 2, 3, 4, 5, 6, 7, 8, 9, 10, 15, 20, 25, 30, 35, 40, 45, 50, 55, or 60 wt%) TDS and/or divalent cations 402. The TDS include the dissolved solids, including dissolved inorganic salts (e.g., monovalent salts (e.g., bicarbonates, chlorides, or sulfates) containing monovalent cations, such as sodium or potassium (e.g., such as sodium chloride (NaCl) or potassium chloride (KCl)), divalent salts (e.g., bicarbonates, chlorides, or sulfates) containing divalent cations, such as magnesium, calcium, or zinc, (e.g., magnesium chloride (MgCl₂), zinc chloride (ZnCl₂) or calcium chloride (CaCl₂)).

Water 401 and/or solution 404 can be produced or available (e.g., seawater) at the wellsite 455 and/or at another wellsite. In embodiments, the solution 404 (and/or water 401 utilized to provide solution 404) utilized to produce precipitation solution 415 in precipitation apparatus 410 includes a brine.

In embodiments, as noted hereinabove, the one or more divalent cations in solution 404 and precipitation solution 415 in precipitation apparatus 410) include calcium (Ca²⁺), magnesium (Mg²⁺), or both Ca²⁺, and Mg²⁺, respectively, and the precipitate includes calcium carbonate (CaCO₃), magnesium carbonate (MgCO₃), or both CaCO₃ and MgCO₃, respectively.

As noted above with reference to FIG. 1 and FIG. 2, precipitating the precipitate 409 at step 110 can include adjusting a pH of the precipitation solution 415 in precipitation apparatus 410 to a pH at which the precipitate 409 precipitates, as indicated at step 202 of FIG. 2, and/or maintaining the pH of the precipitation solution 415 in precipitation apparatus 410 at the pH at which the precipitate 409 precipitates, as indicated at step 204 of FIG. 2. Accordingly, one or more lines 407 can be utilized to add an acid or a base into precipitation apparatus 410 to attain and/or maintain the pH of the precipitation solution 415 in precipitation apparatus 410 during the precipitating of precipitate 409 at step 110 of FIG. 1.

In embodiments, a proton removing agent can be added via the one or more lines 407. The proton removing agent can be selected from hydroxides, organic bases, super bases, oxides, ammonia, carbonates, another proton-removing agent, or combinations thereof. For example, in aspects, the proton-removing agent includes a hydroxide selected from sodium hydroxide (NaOH), potassium hydroxide (KOH), calcium hydroxide (Ca(OH)₂), or magnesium hydroxide (Mg(OH)₂); an organic base selected from primary amines, secondary amines, tertiary amines, aromatic amines, heteroaromatics, or combinations thereof, for example, pyridine, methylamine, imidazole, diisopropylamine, diisopropylethylamine, aniline, benzimidazole, histidine, phophazene, or a combination thereof. In aspects, the proton-removing agent does not include an amine.

With reference now to FIG. 4, during the precipitating of the precipitate at step 110 of FIG. 1, the gas including CO₂ 405 (e.g., obtained from the exhaust gas of fracturing equipment at the wellsite 455 (or by trucking in captured CO₂ from another jobsite, such as from a power plant, cement plant, etc.) introduced into the precipitation apparatus 410 contacts the solution 404. Within precipitation apparatus 410, the CO₂ of the gas including CO₂ 405 reacts with the solution 404 to form carbonic acid (H₂CO₃).

Mixing the gas including CO₂ 405 with the solution 404 allows CO₂ to be solvated to provide an aqueous solution of CO₂, as indicated in Equation (1):

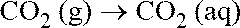

The CO₂ dissolves in the solution 404 to provide aqueous carbonic acid, as indicated in Equation (2):

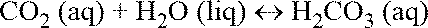

Carbonic acid is a weak acid which dissociates in two steps. With pH of the solution below about 8 to 9, bicarbonate is formed in Step 1.

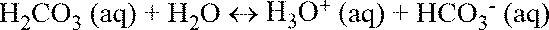

With pH of the solution above about 9 to 10 (by adding proton-removing agent (e.g., a hydroxide (OH⁻) source), carbonate is formed in Step 2.

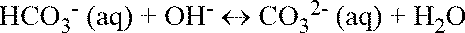

Thus, the proton-removing agent(s) captures the hydronium ions (H₃O⁺) that have been generated from carbonic acid (H₂CO₃) in forming bicarbonate (HCO₃⁻) and carbonate (CO₃²⁻) ions. The divalent metal cations, i.e., Ca²⁺ and/or Mg²⁺, existing in the solution 404 (and precipitation solution 415 in precipitation apparatus 410) react with CO₃²⁻ to form precipitate 409 including one or more carbonates, such as solids of calcium carbonate (CaCO₃) and/or magnesium carbonate (MgCO₃) that will precipitate out of the precipitation solution 415. Reaction of metal cations with carbonate anion forms metal carbonate solids or “precipitate” via Equation (3):

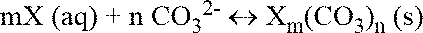

wherein X is a metal cation (or a combination of metal cations) that can chemically bond with a carbonate group; m and n are stoichiometric positive integers. For example, when the solution 404 (and precipitation solution 415 in precipitating apparatus 410) includes the metal cations Ca²⁺ or Mg²⁺, the reactions of Equation (4) and Equation (5) can occur:

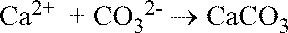

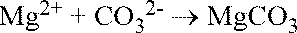

Thus, in embodiments, the dissolution of CO₂ into the solution 404 (e.g., the aqueous solution of divalent cations) to provide precipitation solution 415 in precipitation apparatus 410 produces carbonic acid, a species in equilibrium with both bicarbonate and carbonate. To produce precipitation solids including the one or more carbonates, protons are removed from various species (e.g. carbonic acid, bicarbonate, hydronium, etc.) in the solution 404 (e.g., the divalent cation-containing solution) to shift the equilibrium toward forming carbonate, and allowing rapid precipitation of carbonate-containing solids. As protons are removed, more CO₂ goes into solution in precipitation solution 415 in precipitation apparatus 410.

Reacting of the solution 404 and the gas containing CO₂ 405 in the presence of the base or other proton-removing agent (e.g., introduced via one or more lines 407) within precipitation apparatus 410 provides CO₂-reduced gas 408, that may be obtained from precipitation apparatus 410. In embodiments, CO₂-reduced gas 408 can include a clean air that can, in embodiments, be suitable for venting and/or other use without further treatment. In aspects, the CO₂-reduced gas 408 includes air having less than 0.01, 0.1, or 1.0 volume percent (vol%) CO₂ and/or includes less than 1, 2, 3, 4, 5, 6, 7, 8, 9, 10, or 15 vol% of the CO₂ in the gas including CO₂ 405.

Although depicted as a single apparatus in FIG. 4, precipitation apparatus 410 can include one or a combination of units operable to precipitate the precipitate 409. For example, in embodiments, a system and/or method such as described in U.S. Pat. No. 8,137,444, the disclosure of which is hereby incorporated herein in its entirety for purposes not contrary to this disclosure, can be employed to precipitate the precipitate at step 110 of FIG. 1. Alternate precipitation apparatus 410 and methods, known or yet to be discovered, can be utilized for producing the precipitate including divalent cation carbonates from the gas including CO₂ and the divalent cation solution 404.

As depicted in FIG. 4, the solution 404, the gas including CO₂ 405, and the additional components (e.g., proton-removing agent, acid, base) can be separately introduced into precipitation apparatus 410, in embodiments. Although depicted as introduced separately into precipitation apparatus 410, it is envisaged that, in embodiments, one or more of the gas including CO₂ 405, the solution 404 (or the water 401 and divalent cations 402 thereof), and/or the additional component(s) (e.g., proton-removing agent, acid, base) introduced via the one or more lines 407 can be combined prior to introduction into precipitation apparatus 410. For example, in embodiments, the solution 404 can be combined with the gas including CO₂ 405, and introduced into precipitation apparatus 410 separately from the proton-removing agent or other component(s) introduced via the one or more lines 407.

In embodiments, the precipitation apparatus 410 can include a Venturi reactor, a fluidized bed reactor, a fixed bed reactor, a slurry bubble column reactor, a batch reactor, a semi-batch reactor a continuous stirred tank reactor, a plug flow reactor, another suitable reactor, another suitable reactor, or a combination thereof. In specific applications precipitation apparatus includes a Venturi reactor.

With reference to FIG. 1, method 100 can include, at 120, separating precipitate 409 from the precipitation solution 415. Accordingly, with reference to FIG. 4, system 400 can include a separator 420, fluidly connected with the precipitation apparatus 410 via line 416, and configured to effect the separation of at least a portion 426 of the precipitate 409 introduced into separator 420 with the precipitation solution 415 from a precipitate-reduced solution 425. The at least the portion 426 of the precipitate 409 can be removed from separator 420 as a solid or a slurry of the precipitate. Separator 420 can be any solid/liquid separator operable to separate at least a portion of the water from the precipitation solution 415. By way of non-limiting examples, separator 420 can include a filter, a centrifuge, a decanter, or a gravity settler.

The precipitate-reduced solution 425 can include less TDS (e.g. divalent cations 402) than the solution 404. In aspects, the precipitate-reduced solution 425 can include greater than or equal to about 1, 5, 10, 20, 30, 40, or 50, or from about 0.1 to about 50, from about 1 to about 45, or from about 3 to about 40 weight percent (wt%) TDS or divalent cations. In aspects, the precipitate-reduced solution 425 can include less than or equal to about 0.01, 0.1, or 1.0, or from about 0.001 to about 1, from about 0.01 to about 0.5, or from about 0.1 to about 0.3 weight percent (wt%) TDS or divalent cations. In aspects, the precipitate-reduced solution 425 can include less than or equal to about 0.05, 0.1, or 0.5 weight percent (wt%) of the TDS or divalent cations in the solution 404 or precipitation solution 415 in precipitation apparatus 410. In embodiments, the precipitate-reduced solution 425 can be introduced into mixing apparatus 403 as source of water 401.

System 400 can further include a slurry mixing apparatus 430 (also referred to herein as a WSF mixing apparatus 430) configured to produce a slurry 436 including the at least the portion 426 of the precipitate 409. In embodiments, the slurry 436 can include a wellbore servicing fluid, such as and without limitation, an oil- or water-based drilling fluid. As described further hereinbelow, one or more additional components 433/434, such as, without limitation, water, oil, and/or one or more mud additives, can be combined with the at least the portion 426 of the precipitate 409 in slurry mixing apparatus 430 to produce the slurry 436. In embodiments, the slurry does not include a wellbore servicing fluid. Slurry mixing apparatus 430 can be agitated by an agitator 435. In embodiments, slurry 436 includes water, salt water, brine, and/or produced water. Slurry 436 can further include and may include viscosifiers or thinners to help with flow control and suspension. Viscosifiers can include clays, such as and without limitation, montmorillonite, sepiolite, and attapulgite. Polymers can include xanthan gum, diutan gum, welan gum, guar gum, scleroglucan, hydroxyethyl cellulose, polyanionic cellulose, modified cellulose, polyacrylamide, partially hydrolyzed polyacrylamide, modified polyacrylamides, starch, crosslinked starch, modified starch or a combination thereof. Thinners can include anionic poly acrylamide polymers, tannins, lignosulfonates, pyrophosphates, surfactants, or a combination thereof. For efficient injection conditions, the rheology of the slurry 436 can be monitored and/or modified at a rig at wellsite 455, in real time and/or with traditional lab test equipment for efficient injection conditions.

System 400 further includes a pumping apparatus 440 operable to pump at least a portion of the precipitate 409 (e.g., via pumping of slurry 436) to a storage location, whereby the at least the portion 426 of the precipitate 409 can be stored. For example, in embodiments, pumping apparatus 440 is operable to pump at least a portion of the precipitate 409 (e.g., in slurry 436) downhole (e.g., below a surface 446 of the earth) via a well 450, whereby the at least the portion 426 of the precipitate 409 can be stored downhole. In embodiments, pumping apparatus 440 is utilized to pump the at least the portion 426 of the precipitate 409 downhole (indicated at stream 445) into a reservoir 460 via the well 450, whereby the at least the portion 426 of the precipitate 409 is stored in the reservoir 460. In embodiments, the reservoir 460 includes a depleted oil reservoir.

In embodiments, solution 404 and/or precipitation solution 415 in precipitation apparatus 410 further includes a substrate 411. In such embodiments, precipitating the precipitate 409 at step 110 of FIG. 1 can include precipitating at least a fraction of the precipitate 409 onto the substrate 411. By way of example, and without limitation, the substrate 411 can include hematite, ilmenite, iron titanate, a fibrous substrate, a sponge substrate, or a combination thereof. The precipitating of the precipitate onto the substrate 411 can be effected substantially as described in U.S. Pat. Application No. 16/753,967, the disclosure of which is hereby incorporated herein in its entirety for purposes not contrary to this disclosure. For example, in such embodiments, the precipitating at 110 can include: (a) contacting the solution 404, CO₂, and the substrate 411 to form precipitation solution 415; and (b) allowing at least a portion of the precipitation solution 415 to react and form precipitate 409 (e.g., a plurality of calcium carbonate and/or magnesium carbonate particles) in the presence of the substrate 411. In such embodiments, the precipitate 409 can include the substrate 411 and at least some of the precipitate 409 (e.g., a plurality of calcium carbonate and/or magnesium carbonate particles) dispersed thereon and/or therein. At least a portion of the plurality of calcium carbonate and/or magnesium carbonate particles precipitate in contact with substrate 411. An abrasiveness of the substrate 411 having the precipitate 409 dispersed thereon and/or therein can be greater than an abrasiveness of the substrate 411 in the absence of the plurality of calcium carbonate and/or magnesium carbonate particles. Substrate 411 can be selected from the group consisting of a fibrous substrate, a sponge substrate, and combinations thereof. The fibrous substrate can include a plurality of fibers. Each fiber of the plurality of fibers can be characterized by an aspect ratio of greater than or equal to about 2:1. The sponge substrate can be characterized by a porosity of greater than or equal to about 5 vol.%, based on the total volume of the sponge substrate. In such embodiments, solution 404 can include a calcium source selected from a calcium salt, calcium chloride (CaCl₂), calcium hydroxide (Ca(OH)₂), calcium nitrite (Ca(NO₂)₂), calcium bromate (Ca(BrO₃)₂), calcium bromide (CaBr₂), calcium iodide (CaI₂), calcium formate (Ca(HCOO)₂), calcium acetate (Ca(CH₃COO)₂), calcium lactate (Ca(CH₃CH(OH)COO)₂), or combinations thereof solution 404 can alternatively or additionally include a magnesium source selected from a magnesium salt, magnesium chloride (MgCl₂), magnesium hydroxide (Mg(OH)₂), magnesium nitrite (Mg(NO₂)₂), magnesium bromate (Mg (BrO₃)₂), magnesium bromide (MgBr₂), magnesium iodide (MgI₂), magnesium formate (Mg(HCOO)₂), magnesium acetate (Mg(CH₃COO)₂), magnesium lactate (Mg(CH₃CH(OH)COO)₂), or combinations thereof. In such embodiments, solution 404 can further include another carbonate source in addition to the CO₂, such as, for example, a carbonate source selected from a carbonate, sodium carbonate (Na₂CO₃), sodium bicarbonate (NaHCO₃), potassium carbonate (K₂CO₃), ammonium carbonate ((NH₄)₂CO₃), carbon dioxide (CO₂), or combinations thereof. In sch embodiments, precipitating at 110 can further include heating the precipitation solution including substrate 411 to a temperature of from about 30° C. to about 95° C. In sch embodiments, precipitating at 110 can further include heating the precipitation solution 415 including substrate 411 to a temperature of greater than or equal to about 70° C., wherein at least a portion of the plurality of calcium carbonate particles includes aragonite. The precipitating at 110 can further include agitating the precipitation solution 415, such as by stirring, shaking, blending, mixing, gas bubbling, pumping, or combinations thereof. In embodiments, at least a portion of the precipitate 409 (e.g., calcium carbonate particles and/or magnesium carbonate particles) form by (e.g., calcium carbonate and/or magnesium carbonate) crystal nucleation and growth on a surface of the substrate 411.

In embodiments, the solution 404 (e.g., a TDS water or brine), the gas including CO₂ 405, or both the solution 404 and the gas including CO₂ 405 can be produced at the wellsite 455. Alternatively, the solution 404, the gas including CO₂ 405, or both the solution 404 and the gas including CO₂ 405 can be produced at one or more jobsites other than the wellsite 455 at which the precipitating of step 110 and/or the storing at step 140 of FIG. 1 are carried out. To avoid transport (e.g., via railway, truck, tanker, pipeline, etc.) of large volumes of gas or water, it can be desirable, in embodiments, that the solution 404, the gas including CO₂ 405, or both the solution 404 and the gas including CO₂ 405 are produced or otherwise available at the wellsite 455. However, in aspects, the solution 404 is produced at a first different jobsite (i.e., not at the wellsite 455 at which steps 110 and/or 140 of method 100 are performed), and/or the gas including CO₂ 405 is produced at a second different jobsite (i.e., not at the wellsite 455 at which steps 110 and/or 140 of method 400 are performed), which second different jobsite may be the same as or different from the first different jobsite at which the solution 404 is produced. Any or all of the wellsite 455, the first different jobsite, and the second different jobsite can, in embodiments, be a wellsite.

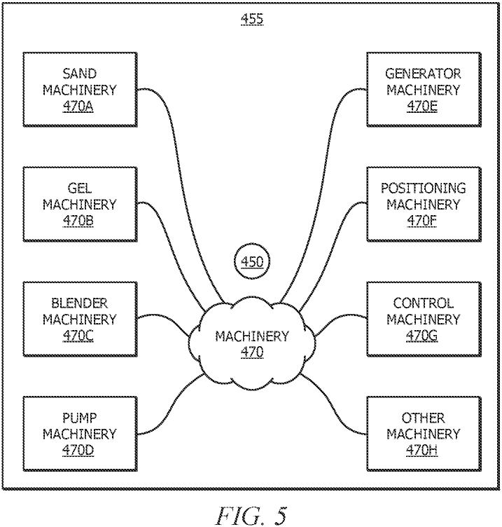

As noted above, the gas including CO₂ 405 can be produced at the wellsite 455 and/or at another jobsite. Generally, the gas including CO₂ 405 can be, include, or primarily include any gas including CO₂, for example, atmospheric air (including about 415 ppm CO₂) available at the wellsite 455 at which the precipitating at 110 is carried out. In embodiments, the gas including CO₂ 405 can include greater than or equal to about 0.04, 0.1, 0.5, 1, 2, 3, 4, 5, 6, 7, 8, 9, 10, 20, 30, 40, 50, 60, 70, 80, 90, 95, or 100 volume percent (vol.%) CO₂. By way of examples, the gas including CO₂ 405 can include a waste gas, or one or more components thereof, produced at the wellsite 455 or another jobsite, such as, without limitation, one or more wellsites or industrial plants. The one or more industrial plants can include, without limitation, a cement plant, a chemical processing plant, a mechanical processing plant, a refinery, a steel plant, a power plant (e.g., a gas power plant, a coal power plant, etc.), or a combination and/or a plurality thereof. In aspects, the gas including CO₂ 405 includes a waste gas that is a product of fuel combustion, for example, the product of an internal combustion engine, or a gas fired turbine engine, such as, for example, from a microgrid having electric pumps. In aspects, the internal combustion engine includes an engine fueled by diesel, natural gas, gasoline, or a combination thereof (e.g., a diesel engine, or a hybrid engine that is fueled by diesel and natural gas). In specific embodiments, the another jobsite is a wellsite. In such aspects, the gas including CO₂ 405 can be produced at the wellsite 455 and/or another jobsite. FIG. 5 is a schematic of a plurality of machinery 180 that may be located and operated a wellsite 455 for performing a subterranean formation operation and that may produce gas including CO₂ 405, according to one or more embodiments of the present disclosure. The plurality of machinery 470 can be located and operated at wellsite 455 for performing a subterranean formation operation, according to one or more embodiments of the present disclosure, and the gas including CO₂ 405 can, in embodiments, be obtained therefrom. For example, the gas including CO₂ can be produced at the wellsite 455 having wellbore 450 from machinery used to perform a formation 460 operation. The machinery 470 may include one or more internal combustion or other suitable engines that consume fuel to perform work at the wellsite and produce exhaust gas including CO₂.

The wellbore 450 may be a hydrocarbon-producing wellbore (e.g., oil, natural gas, and the like) or another type of wellbore for producing other resources (e.g., mineral exploration, mining, and the like). Machinery typically associated with a subterranean formation 460 operation related to a hydrocarbon producing wellbore, and from which the gas including CO₂ 405 can be produced can be utilized to perform such operations as, for example, a cementing operation, a fracturing operation, or other suitable operation where equipment is used to drill, complete, produce, enhance production, and/or work over the wellbore 450. Other surface operations may include, for example, operating or construction of a facility.

The machinery 470 from which the gas including CO₂, can be produced, in embodiments, can include sand machinery 470A, gel machinery 470B, blender machinery 470C, pump machinery 470D, generator machinery 470E, positioning machinery 470F, control machinery 470G, and/or other machinery 470H. The machinery 470 may be, for example, truck, skid or rig-mounted, or otherwise present at the wellsite 455, without departing from the scope of the present disclosure. The sand machinery 470A may include transport trucks or other vehicles for hauling to and storing at the wellsite 455 sand for use in an operation. The gel machinery 470B may include transport trucks or other vehicles for hauling to and storing at the wellsite 455 materials used to make a gelled treatment fluid for use in an operation. The blender machinery 470C may include blenders, or mixers, for blending materials at the wellsite 455 for an operation. The pump machinery 470D may include pump trucks or other vehicles or conveyance equipment for pumping materials down the wellbore 450 for an operation. The generator machinery 470E may include generator trucks or other vehicles or equipment for generating electric power at the wellsite 455 for an operation. The electric power may be used by sensors, control machinery, and other machinery. The positioning equipment 470F may include earth movers, cranes, rigs or other equipment to move, locate or position equipment or materials at the wellsite 455 or in the wellbore 450.

The control machinery 470G may include an instrument truck coupled to some, all, or substantially all of the other equipment at the wellsite 455 and/or to remote systems or equipment. The control machinery 470G may be connected by wireline or wirelessly to other equipment to receive data for or during an operation. The data may be received in real-time or otherwise. In another embodiment, data from or for equipment may be keyed into the control machinery.

The control machinery 470G may include a computer system for planning, monitoring, performing or analyzing the job. Such a computer system may be part of a distributed computing system with data sensed, collected, stored, processed and used from, at or by different equipment or locations. The other machinery 470H may include equipment also used at the wellsite 455 to perform an operation.

In other examples, the other machinery 470H may include personal or other vehicles used to transport workers to the wellsite 455 but not directly used at the wellsite 455 for performing an operation.

Many if not most of these various machinery 470 at the wellsite 455 accordingly utilize a diesel or other fuel types to perform their functionality. Such fuel is expended and exhausted as exhaust gas, such as exhaust gas including CO₂, considered a significant greenhouse gas and contributor to ocean acidification. The embodiments described herein provide a process for capturing, absorbing, and, when applicable, reusing CO₂ from such machinery 470 located and operated at a wellsite, thus reducing atmospheric CO₂ emissions, while reducing material and time costs. It is to be appreciated that other configurations of the wellsite 455 may be employed, without departing from the scope of the present disclosure. Although a number of various machinery at a jobsite (e.g., a wellsite 455) have been mentioned, many other machinery may utilize diesel or other fuel that creates exhaust gas including CO₂ that may conventionally be exhausted into the atmosphere, but herein utilized to form divalent carbonates that are stored downhole as described herein.

In some embodiments, the present disclosure provides capturing exhaust gas including CO₂ from such machinery 470 located and operated at a wellsite 455 and utilizing such exhaust gas as the gas including CO₂ 405.

Although described hereinabove with reference to a wellsite 455, the source of the gas including CO₂ 405 that is contacted with the solution 404 in the method 100 may be any convenient CO₂ source. The CO₂ source is a gaseous CO₂ source. This gaseous CO₂ may vary widely, ranging from air, industrial waste streams, etc. As noted above, the gaseous CO₂ can, in certain instances, include atmospheric air or a waste product from an industrial plant. The nature of the industrial plant may vary in these embodiments, where industrial plants of interest include power plants, chemical processing plants, and other industrial plants that produce CO₂ as a byproduct. By waste stream is meant a stream of gas (or analogous stream) that is produced as a byproduct of an active process of the industrial plant, e.g., an exhaust gas. The gaseous stream may be substantially pure CO₂ or a multi-component gaseous stream that includes CO₂ and one or more additional gases. Multi-component gaseous streams (containing CO₂) that may be employed as a CO₂ source in embodiments of the subject methods include both reducing, e.g., syngas, shifted syngas, natural gas, and hydrogen and the like, and oxidizing condition streams, e.g., flue gases from combustion. Particular multi-component gaseous streams of interest that may be treated according to the subject invention include: oxygen containing combustion power plant flue gas, turbo charged boiler product gas, coal gasification product gas, shifted coal gasification product gas, anaerobic digester product gas, wellhead natural gas stream, reformed natural gas or methane hydrates, and the like.

As noted above, in aspects, the gas including CO₂ 405 includes greater than or equal to about 0.0.4, 0.05, 0.1, 0.5, 1, 2, 3, 4, 5, 6, 7, 8, 9, 10, 15, 20, 25, 30, 40, 50, 60, 70, 80, 90, 95, 96, 97, 98, 99, or 100 volume percent (vol%) CO₂. In aspects, the gas including CO₂ includes atmospheric air having about 415 ppm CO₂ In aspects, the gas including CO₂ 405 includes primarily CO₂ (e.g., greater than or equal to about 50, 60, 70, 80, 90, 95, 96, 97, 98, 99, or 100 volume percent (vol%) CO₂). For example, when the gas including CO₂ 405 is obtained from a waste gas produced at a different jobsite (e.g., at an another jobsite) than the wellsite 455 at which steps 110 and/or 140 of method 100 are performed, CO₂ can be separated from the waste gas in order to reduce a volume of gas to be transported to the wellsite 455 at which steps 110 and/or 140 are performed. For example, when the gas including CO₂ 405 includes a flue gas from a power plant, which typically contains from about 7 to about 10 vol.% CO₂, the method 100 can further include transporting the gas including CO₂ 405 (or a waste gas from which the gas including CO₂ is obtained) from the another jobsite at which the waste gas is obtained to the wellsite 455. In embodiments, the method 100 can further include separating the gas including CO₂ 405 from the waste gas including CO₂, to reduce a volume of gas, e.g., for transport. Although the separating of the gas including CO₂ 405 from the waste gas including CO₂ can be performed at the wellsite 455 at which step 110 or 140 of the method 100 is performed (e.g., after transport of the waste gas from the another jobsite at which the waste gas is obtained and/or produced to the wellsite 455 at which step 110 or 140 is performed), to facilitate transportation, the separating of the gas including CO₂ 405 from the waste gas including CO₂ can be performed at the another jobsite at which the waste gas is produced and/or obtained and subsequently, the gas including CO₂ 405 can be transported to the wellsite 455 at which step 110 and/or 140 of the method 100 is performed. Separating the gas including CO₂ 405 from the waste gas including CO₂ can further include separating via amine absorption, calcium oxide (CaO) absorption, filtration, packed bed, another technique, or a combination thereof. Accordingly, when present, the separating of the gas including CO₂ 405 from the waste gas including CO₂ can be effected at another jobsite and (e.g., only) the gas including CO₂ 405 transported to the wellsite 455 at which step 110 and/or 140 of method 100 is performed.

In embodiments, the precipitate 409 produced in precipitation apparatus 410 can have an average particle size in a range of from about 0.1 micrometer (µm) to about 100 µm; if aggregates of the precipitated particulates form, the aggregates can have size in a range of from a few to about 10 or 20 millimeters or more. The wellbore servicing fluid of this disclosure can be any suitable wellbore servicing fluid (WSF). As used herein, a “servicing fluid” or “treatment fluid” refers generally to any fluid that can be used in a subterranean application in conjunction with a desired function and/or for a desired purpose, including but not limited to fluids used to drill, complete, work over, fracture, repair, or in any way prepare a wellbore for the recovery of materials residing in a subterranean formation penetrated by the wellbore. Examples of wellbore servicing fluids include, but are not limited to, cement slurries, drilling fluids or muds, spacer fluids, lost circulation fluids, fracturing fluids, gravel packing fluids, diverting fluids, or completion fluids. The servicing fluid is for use in a wellbore that penetrates a subterranean formation. It is to be understood that “subterranean formation” encompasses both areas below exposed earth and areas below earth covered by water such as ocean or fresh water. In embodiments, and without limitation, the WSF can be a fracturing fluid, a gravel packing fluid, a stimulation fluid, an acidizing fluid, a conformance control fluid, a clay control fluid, a scale control fluid, an enhanced oil recovery fluid, a surfactant flooding fluid, an energized fluid, a secondary recovery fluid, an injection fluid, or a combination thereof.

The WSF can include a base fluid 433 that can be added via one or more inlet lines of WSF mixing apparatus 430. The base fluid 433 can be present in a sufficient amount to form a pumpable WSF. For example, in embodiments, the WSF includes an aqueous base fluid. Herein, an aqueous base fluid 433 refers to a fluid having less than or equal to about 20 vol.%, 15 vol.%, 10 vol.%, 5 vol.%, 2 vol.%, or 1 vol.% of a non-aqueous fluid based on the total volume of the WSF. In embodiments, the aqueous base fluid has a pH of greater than or equal to about -1, 0, 1, 2, 3, 4, 5, 6, 7, or 8, a pH of less than or equal to about 8, 7, 6, 5, 4, 3, 2, 1, or 0. Aqueous base fluids that can be utilized in the WSF include any aqueous fluid suitable for use in subterranean applications, provided that the aqueous base fluid is compatible with any other components of the WSF. For example, the WSF can include water or a brine. In embodiments, the base fluid includes an aqueous brine. In such embodiments, the aqueous brine generally includes water and an inorganic monovalent salt, an inorganic multivalent salt, or both. The aqueous brine can be naturally occurring or artificially-created. Water present in the brine can be from any suitable source, examples of which include, but are not limited to, sea water, tap water, freshwater, water that is potable or non-potable, untreated water, partially treated water, treated water, produced water, city water, well-water, surface water, or combinations thereof. The salt or salts in the water can be present in an amount ranging from greater than about 0 % by weight to a saturated salt solution, alternatively from about 1 wt% to about 18 wt%, or alternatively from about 2 wt% to about 7 wt%, by weight of the aqueous fluid. In embodiments, the salt or salts in the water can be present within the base fluid in an amount sufficient to yield a saturated brine.

Nonlimiting examples of aqueous brines suitable for use in the present disclosure include chloride-based, bromide-based, phosphate-based or formate-based brines containing monovalent and/or polyvalent cations, salts of alkali and alkaline earth metals, or combinations thereof. Additional examples of suitable brines include, but are not limited to: NaCl, KCl, NaBr, CaCl₂, CaBr₂, ZnBr₂, ammonium chloride (NH₄Cl), potassium phosphate, sodium formate, potassium formate, cesium formate, or combinations thereof. In embodiments, the aqueous fluid includes a brine. The brine can be present in an amount of from about 40 wt% to about 99.8 wt%, alternatively from about 70 wt% to about 99.5 wt%, or alternatively from about 90 wt% to about 99 wt%, based on the total weight of the WSF. Alternatively, the aqueous base fluid can include the balance of the WSF after considering the amount of the other components used.

In embodiments, the (e.g., aqueous) base fluid 433 is present in the wellbore servicing fluid in an amount of from about 40 wt% to about 99.8 wt%, alternatively from about 70 wt% to about 99.5 wt%, or alternatively from about 90 wt% to about 99 wt%, based on the total weight of the WSF.

In embodiments in which the slurry 436 is not a WSF, base fluid 433 can include, for example, water, and one or more lines 433/434 can be absent or can be utilized to introduce one or more additional components to the slurry 436 prior to introduction to a storage location (e.g., downhole in a reservoir 460). In embodiments in which method 100 does not include separating at 120 or forming a slurry at 130, separator 420 and slurry mixing apparatus 430 can be absent. That is, in embodiments, the precipitation solution 415 including the precipitate 409 can be removed from precipitation apparatus 410 and all or a portion thereof pumped to a final storage location (e.g., a reservoir 460), for example, without mixing with additional components, via pumping apparatus 440.

The components of the WSF can further include additional components or additives (e.g., one or more additives) as deemed appropriate for improving the properties of the fluid. Such components or additives can vary depending on the intended use of the fluid in the wellbore. Examples of such additives include, but are not limited to pH adjusting agents, bases, acids, pH buffers, surfactants, emulsifiers, conventional relative permeability modifiers, lime, organic/inorganic viscosifiers, gelling agents, crosslinkers, weighting agents, glass fibers, carbon fibers, suspending agents, clays, clay control agents, fluid loss control additives, fluid loss enhancer, dispersants, flocculants, conditioning agents, dispersants, water softeners, acids, foaming agents, proppants, salts, mutual solvents, oxidation and corrosion inhibitors, scale inhibitors, thinners, thickeners, scavengers, gas scavengers, lubricants, breakers, friction reducers, antifoam agents, bridging agents, strengtheners (e.g., wellbore strengtheners to increase a hoop stress on the formation), and the like, or combinations thereof. These additives can be introduced singularly or in combination using any suitable methodology and in amounts effective to produce the desired improvements in fluid properties. In embodiments, the at least the portion 426 of the precipitate 409 is added to the WSF and serves as one of the herein mentioned additives (e.g., as a thickener, a wellbore strengthener, a carbonate bridging agent, a fluid loss control additive (e.g., a fluid loss enhancer)).

In embodiments, the WSF can further include a surfactant and/or demulsifier. Generally, surfactants are amphiphilic molecules that contain a hydrophilic head portion (e.g., polar head group; hydrophilic component) and a hydrophobic tail portion (e.g., non-polar tail group; hydrophobic component; lipophilic component). Typically, the hydrophobic tail portion can be a linear or branched alkyl chain, while the hydrophilic head portion can be a polar functional group (e.g., non-ionic functional group, cationic functional group, anionic functional group). As will be appreciated by one of skill in the art, and with the help of this disclosure, and without being limited by theory, owing to distinct differences in hydrophilicity/hydrophobicity between the hydrophilic head and the hydrophobic tail, surfactants generally reside at interfaces between various phases (e.g., a liquid-solid interface; a liquid-gas interface, a liquid-liquid interface between immiscible liquids; etc.).

Demulsifiers (or emulsion breakers), are a class of chemicals used to separate emulsions, for example, water in oil. In an aspect, the demulsifier prevents and/or breaks an emulsion when it comes in contact with crude oil or breaks an emulsion of the WSF. The demulsifier can include, for example and without limitation, acid catalyzed phenol-formaldehyde resins, base catalyzed phenol-formaldehyde resins, epoxy resins, polyethyleneimines, polyamines, di-epoxides, polyols, dendrimer, silicon particles, silica, alumina, or a combination thereof.

Nonlimiting example of commercially available surfactants (e.g., detergents, emulsions, microemulsions, etc.) suitable for use in the present disclosure include CFS™-485 casing cleaner, LOSURF™-300M surfactant, LOSURF™-357 surfactant, LOSURF™-400 surfactant, LOSURF™-2000S surfactant, LOSURF™-2000M surfactant, LOSURF™-259 nonemulsifier, NEA-96M™ surfactant, BDF™-442 surfactant, and BDF™-443 surfactant. CFS™-485 casing cleaner is a blend of surfactants and alcohols; LOSURF™-300M surfactant is a nonionic surfactant; LOSURF™-357 surfactant is a nonionic liquid surfactant; LOSURF™-400 surfactant is a nonemulsifier; LOSURF™-2000S surfactant is a blend of an anionic nonemulsifier and an anionic hydrotrope; LOSURF™-2000M surfactant is a solid surfactant; LOSURF™-259 nonemulsifier is a nonionic, nonemulsfier blend; NEA-96M™ surfactant is a general surfactant and nonemulsifier; BDF™-442 surfactant and BDF™-443 surfactant are acid-responsive surfactants, all of which are commercially available from Halliburton Energy Services.

Other nonlimiting example of commercially available surfactants (e.g., detergents, emulsions, microemulsions, etc.) suitable for use in the present disclosure include TERGITOL™ 15-S-9 surfactant, which is commercially available from The Dow Chemical Company; TERGITOL™ 15-S-7 surfactant, which is commercially available from The Dow Chemical Company; AMADOL® 511 nonionic alkanolamide water-based mud additive, which is commercially available from Akzo Nobel Surface Chemistry; STEPANOL® WAT-K anionic surfactant, which is commercially available from Stepan; BASAROL® demulsifiers, which are commercially available from BASF; EXXAL™ alcohols, which are commercially available from ExxonMobil; CLEARBREAK® demulsifiers, which are commercially available from Solvay; UNIDYNE™ TG-5543 weak cationic water emulsion, which is commercially available from Daikin; and the like; or combinations thereof.

In some embodiments, the additional component(s) can be present in the WSF in an amount of from about 0.01 wt% to about 10 wt%, alternatively from about 0.01 wt% to about 5 wt%, alternatively from about 0.01 wt% to about 3 wt%, alternatively from about 0.05 wt% to about 2.5 wt%, alternatively from about 0.1 wt% to about 2 wt%, alternatively from about 0.5 wt% to about 1.5 wt%, alternatively from about 0.05 wt% to about 10 wt%, alternatively from about 0.1 wt% to about 7.5 wt%, or alternatively from about 1 wt% to about 5 wt%, based on the total weight of the WSF.

In embodiments, the WSF includes a pH adjusting agent. In some embodiments, the pH adjusting agent is a base. In other embodiments, the pH adjusting agent is an acid. In some other embodiments, the pH adjusting agent is a pH buffer.

In embodiments, a base can be used for increasing the pH of a solution by about 0.1 pH units, alternatively, about 0.2 pH units, alternatively, about 0.5 pH units, alternatively, about 1.0 pH units, alternatively, about 1.5 pH units, alternatively, about 2.0 pH units, alternatively, about 2.5 pH units, alternatively, about 3.0 pH units, alternatively, about 4.0 pH units, alternatively, about 5.0 pH units, alternatively, about 6.0 pH units, or alternatively, about 7.0 or more pH units.

Nonlimiting examples of bases suitable for use in the present disclosure include ammonium and alkali metal carbonates and bicarbonates, Na₂CO₃, K₂CO₃, CaCO₃, MgCO₃, NaHCO₃, KHCO₃, alkali and alkaline earth metal oxides, BaO, SrO, Li₂O, CaO, Na₂O, K₂O, MgO, alkali and alkaline earth metal hydroxides, NaOH, NH₄OH, KOH, LiOH, Mg(OH)₂, alkali and alkaline earth metal phosphates, Na₃PO₄, Ca₂(PO₄)₂, and the like, or combinations thereof. In embodiments, the base can be included within the WSF in a suitable amount that will provide the desired pH.

In embodiments, an acid can be used for decreasing the pH of a solution by about 0.1 pH units, alternatively, about 0.2 pH units, alternatively, about 0.5 pH units, alternatively, about 1.0 pH units, alternatively, about 1.5 pH units, alternatively, about 2.0 pH units, alternatively, about 2.5 pH units, alternatively, about 3.0 pH units, alternatively, about 4.0 pH units, alternatively, about 5.0 pH units, alternatively, about 6.0 pH units, or alternatively, about 7.0 or more pH units.

Nonlimiting examples of acids suitable for use in the present disclosure include mineral acids, hydrochloric acid, sulphuric acid, sulphonic acid, sulphamic acid; organic acids, formic acid, acetic acid, monochloroacetic acid, dichloroacetic acid, trichloroacetic acid, sulphinic acid, methanesulfonic acid, lactic acid, glycolic acid, oxalic acid, propionic acid, butyric acid; ammonium salts, and salts of weak bases, such as for example organic amines; or combinations thereof. In embodiments, the acid can be included within the WSF in a suitable amount that will provide the desired pH.

In embodiments, the pH adjusting agent is a pH buffer. The pH buffer includes a combination of weak acids or weak bases, in combination with the corresponding salts to maintain the pH of a fluid in a desired range. Nonlimiting examples of chemical combinations which can be used as pH buffers include acetic acid/sodium acetate; sodium carbonate/sodium bicarbonate; and sodium dihydrogen phosphate/sodium monohydrogen phosphate.

In embodiments, the WSF is an aqueous based fracturing fluid including a proppant (which can, in embodiments include at least a portion of the precipitate 409, optionally subsequent further processing), surfactants, and an aqueous base fluid.

In embodiments, the wellbore service being performed is a fracturing operation, wherein a WSF is placed (e.g., pumped downhole) in the formation 460. In such embodiments, the WSF can be a fracturing fluid with a pH of greater than or equal to about 2, 3, 4, 5, or 6. As will be understood by one of ordinary skill in the art, the particular composition of a fracturing fluid will be dependent on the type of formation that is to be fractured. Fracturing fluids typically include an aqueous fluid (e.g., water), a proppant, a surfactant, acid, friction reducers, gelling agents, scale inhibitors, pH-adjusting agents, oxygen scavengers, breakers, crosslinkers, iron-control agents, corrosion inhibitors, bactericides, and the like. Such components can include the additives, and can be included via one or more lines 434.

In embodiments, the fracturing fluid includes a propping agent. In embodiments, the propping agent can include any suitable particulate material, which can be used to prop fractures open, i.e., a propping agent or a proppant. As used herein, a proppant refers to a particulate material that is suitable for use in a proppant pack or a gravel pack. When deposited in a fracture, the proppant can form a proppant pack, resulting in conductive channels through which fluids can flow to the wellbore. The proppant functions to prevent the fractures from closing due to overburden pressures.

Nonlimiting examples of proppants suitable for use in this disclosure include silica (sand), graded sand, Ottawa sands, Brady sands, Colorado sands; resin-coated sands; gravels; synthetic organic particles, nylon pellets, high density plastics, teflons, rubbers, resins; ceramics, aluminosilicates; glass; sintered bauxite; quartz; aluminum pellets; ground or crushed shells of nuts, walnuts, pecans, almonds, ivory nuts, brazil nuts, and the like, ground or crushed seed shells (including fruit pits) of seeds of fruits, plums, peaches, cherries, apricots, and the like; ground or crushed seed shells of other plants (e.g., maize, corn cobs or corn kernels); crushed fruit pits or processed wood materials, materials derived from woods, oak, hickory, walnut, poplar, mahogany, and the like, including such woods that have been processed by grinding, chipping, or other form of particleization; or combinations thereof. In embodiments, the proppant includes sand. In aspects, the propping agent includes and/or is derived from the precipitate 409.

The proppants can be of any suitable size and/or shape. In embodiments, a proppant suitable for use in the present disclosure can have an average particle size in the range of from about 2 to about 400 mesh, alternatively from about 8 to about 100 mesh, or alternatively from about 10 to about 70 mesh, U.S. Sieve Series.

In embodiments, a proppant can be present in the WSF in an amount of from about 0. 1 pounds per gallon (ppg) to about 28 ppg, alternatively from about 0.1 ppg to about 14 ppg, or alternatively from about 0.1 ppg to about 8 ppg, based on the volume of the fracturing or gravel-packing fluid.

In embodiments, the wellbore service being performed is a gravel packing operation, wherein a WSF is placed (e.g., pumped downhole) in the formation. In such embodiments, the WSF is a gravel packing fluid. A “gravel pack” is a term commonly used to refer to a volume of particulate materials (such as gravel and/or sand) placed into a wellbore to at least partially reduce the migration of unconsolidated formation particulates into the wellbore. Gravel packing operations commonly involve placing a gravel pack screen in the wellbore neighboring a desired portion of the subterranean formation, and packing the surrounding annulus between the screen and the subterranean formation with particulate materials that are sized to prevent and inhibit the passage of formation solids through the gravel pack with produced fluids. In some instances, a screenless gravel packing operation can be performed. In embodiments, the gravel pack includes a proppant material of the type previously described herein.

By enabling the utilization of a gas including CO₂ 405 (e.g., air) to produce a precipitate 409 including one or more divalent cation carbonates 402, and placing at least a portion 426 of the precipitate 409 downhole in a formation/reservoir 460 via a well 450, the herein disclosed system (e.g., system 400 of FIG. 4) and method (e.g., method 100 of FIG. 1, method 300 of FIG. 3) provide for sequestration and long term storage of CO₂ (e.g., in the divalent cation carbonate precipitate form). Thus, in embodiments, the herein disclosed system and method provide for a reduction in CO₂ emissions (e.g., at a wellsite 455). In embodiments, a revenue stream can be obtained for CO₂ removal, as described herein, and/or for the disposal/storage of precipitate 409 (e.g., downhole).

In embodiments, the system and method enable atmospheric carbon dioxide sequestration. Alternatively, or additionally, the system and method of this disclosure can provide for the removal of carbon dioxide from a gas other than or in addition to air, such as, without limitation, a produced well gas and/or a flare gas.

In embodiments, employing exhaust gas from the rig as the gas including CO₂ 405 can provide for a reduced CO₂ footprint on location. In embodiments, at least a portion 426 of the precipitate 409 can be utilized (e.g., onsite) in a WSF (e.g., as a carbonate bridging agent or thickener) utilizing during a wellbore servicing operation (e.g., during drilling). In embodiments, the carbonate precipitate 409 can be deposited onto a solid matrix (e.g., hematite), as described hereinabove) to improve its properties (e.g., reduce abrasiveness of the solid matrix). In embodiments, pump a flare gas through precipitation apparatus 410 before and after flaring can be utilized to reduce a CO₂ footprint on location.

### ADDITIONAL DISCLOSURE

The following are non-limiting, specific embodiments in accordance with the present disclosure:

In a first embodiment, a method comprises: precipitating a precipitate comprising one or more divalent cation carbonates from a solution comprising a divalent cation of each of the one or more divalent cation carbonates; and storing at least a portion of the precipitate downhole by placing the at least the portion of the precipitate downhole via a well.

A second embodiment can include the method of the first embodiment, wherein the one or more divalent cation carbonates comprise calcium carbonate (CaCO₃), magnesium carbonate (MgCO₃), or both CaCO₃ and MgCO₃, and wherein the solution comprises the divalent cation calcium (Ca²⁺), magnesium (Mg²⁺), or both Ca²⁺, and Mg²⁺, respectively.

A third embodiment can include the method of any one of the first embodiment or the second embodiment further comprising: separating the precipitate from the solution; and forming a slurry comprising the at least the portion of the precipitate, wherein placing the at least the portion of the precipitate downhole via the well comprises pumping the slurry downhole via the well.

A fourth embodiment can include the method of the third embodiment, wherein the slurry comprise a wellbore servicing fluid.

A fifth embodiment can include the method of the fourth embodiment, wherein the wellbore servicing fluid comprises a drilling fluid.

A sixth embodiment can include the method of any one of the first to fifth embodiments further comprising plugging and abandoning the well.

A seventh embodiment can include the method of any one of the first to sixth embodiments, wherein precipitating the precipitate further comprises: contacting a gas comprising carbon dioxide (CO₂) with the solution, whereby the precipitate precipitates from the solution, and a reduced CO₂ gas is provided.

An eighth embodiment can include the method of the seventh embodiment, wherein the gas comprising CO₂ comprises a produced gas from the or another well, a flare gas (e.g., a gas conventionally sent to flare), air, an exhaust gas, a flue gas, or a combination thereof.

A ninth embodiment can include the method of the eighth embodiment, wherein the gas comprises a flare gas, and wherein the method comprises contacting the flare gas with the solution to provide a reduced CO₂ gas comprising a reduced CO₂ flare gas, flaring the reduced CO₂ flare gas to produce a flared gas, and contacting the flared gas with the solution, whereby additional precipitate precipitates.

A tenth embodiment can include the method of any one of the eighth or ninth embodiments, wherein the gas comprising CO₂ comprises atmospheric air.

An eleventh embodiment can include the method of any one of the seventh to tenth embodiments, wherein contacting the gas comprising CO₂ with the solution further comprises sparging, or otherwise passing the gas comprising CO₂ through the solution.

A twelfth embodiment can include the method of any one of the seventh to eleventh embodiments further comprising: adjusting a pH of the solution to a pH at which the precipitate precipitates.

A thirteenth embodiment can include the method of the twelfth embodiment further comprising maintaining the pH at the pH at which the precipitate precipitates during the precipitating of the precipitate.

A fourteenth embodiment can include the method of any one of the first to thirteenth embodiments, wherein the solution comprises a brine.

A fifteenth embodiment can include the method of any one of the first to fourteenth embodiments, wherein the solution further comprises a substrate, and wherein precipitating the precipitate comprises precipitating at least a fraction of the precipitate onto the substrate.

A sixteenth embodiment can include the method of the fifteenth embodiment, wherein the substrate comprises hematite, ilmenite, iron titanate a fibrous substrate, a sponge substrate, or a combination thereof.

In a seventeenth embodiment, a system comprises: a precipitation apparatus configured for contacting a solution comprising one or more divalent cations with a gas comprising carbon dioxide (CO₂) to precipitate a precipitate, wherein the precipitate comprises a carbonate of each of the one or more divalent cations; and a pumping apparatus operable to pump at least a portion of the precipitate downhole via a well, whereby the at least the portion of the precipitate is stored downhole.

An eighteenth embodiment can include the system of the seventeenth embodiment, wherein the one or more divalent cations comprise calcium (Ca²⁺), magnesium (Mg²⁺), or both Ca²⁺, and Mg²⁺, respectively, and wherein the precipitate comprises calcium carbonate (CaCO₃), magnesium carbonate (MgCO₃), or both CaCO₃ and MgCO₃, respectively.

A nineteenth embodiment can include the system of any one of the seventeenth or eighteenth embodiments further comprising: a separator configured to separate the at least the portion of the precipitate from the solution; a mixing apparatus configured to produce a slurry comprising the at least the portion of the precipitate; or both the separator and the mixing apparatus.

A twentieth embodiment can include the system of the nineteenth embodiment, wherein the separator comprises a centrifuge, a settler, a decanter, or a combination thereof.

A twenty first embodiment can include the system of any one of the seventeenth to twentieth embodiments, wherein the precipitation apparatus comprises an absorber, a bubbler, a sparger, or a combination thereof.

A twenty second embodiment can include the system of any one of the seventeenth to twenty first embodiments, wherein the pumping apparatus is operable to pump the at least the portion of the precipitate downhole into a reservoir via the well, and wherein the at least the portion of the precipitate is stored in the reservoir.

A twenty third embodiment can include the system of the twenty second embodiment, wherein the reservoir comprises a depleted oil reservoir.

A twenty fourth embodiment can include the system of any one of the seventeenth to twenty third embodiments, wherein the gas comprising CO₂ comprises a produced gas, a flare gas, air, a flue gas, an exhaust gas, or a combination thereof, from the or another well.

A twenty fifth embodiment can include the system of the twenty fourth embodiment, wherein the gas comprising CO₂ comprises atmospheric air.

A twenty sixth embodiment can include the system of any one of the seventeenth to twenty fifth embodiments, wherein the solution comprises a brine.

A twenty seventh embodiment can include the system of any one of the seventeenth to twenty sixth embodiments further comprising a solution mixing apparatus configured to contact water with the one or more divalent cations to form the solution.

In a twenty eighth embodiment, a method of sequestering carbon dioxide (CO₂) comprises: forming a precipitate comprising one or more divalent cation carbonates by contacting a solution comprising a divalent cation of each of the one or more divalent cation carbonates with a gas comprising CO₂; and introducing at least a portion of the precipitate into a reservoir by pumping a slurry comprising the at least the portion of the precipitate downhole into the reservoir via a well.

A twenty ninth embodiment can include the system of the twenty eighth embodiment, wherein the gas comprising CO₂ comprises, consists essentially of, or consists of air.

A thirtieth embodiment can include the method of the twenty ninth embodiment, wherein the air comprises atmospheric air.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl +k^{∗} (Ru-Rl), wherein k is a variable ranging from 1 percent to 100 percent with a 1 percent increment, i.e., k is 1 percent, 2 percent, 3 percent, 4 percent, 5 percent, ..... 50 percent, 51 percent, 52 percent, ....., 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
precipitating a precipitate comprising one or more divalent cation carbonates from a solution comprising a divalent cation of each of the one or more divalent cation carbonates, wherein precipitating the precipitate comprises contacting a gas comprising carbon dioxide (CO₂) with the solution; and
storing at least a portion of the precipitate downhole by placing the at least the portion of the precipitate downhole via a well.

2. The method of claim 1, wherein the one or more divalent cation carbonates comprise calcium carbonate (CaCO₃), magnesium carbonate (MgCO₃), or both CaCO₃ and MgCO₃, and wherein the solution comprises the divalent cations calcium (Ca²⁺), magnesium (Mg²⁺), or both Ca²⁺, and Mg²⁺, respectively.

3. The method of claim 1 further comprising:
separating the precipitate from the solution; and
forming a slurry comprising the at least the portion of the precipitate,
wherein placing the at least the portion of the precipitate downhole via the well comprises pumping the slurry downhole via the well.

4. The method of claim 3, wherein the slurry comprises a wellbore servicing fluid.

5. The method of claim 4, wherein the wellbore servicing fluid comprises a drilling fluid.

6. The method of claim 1, wherein contacting the gas comprising carbon dioxide (CO₂) with the solution forms a precipitation solution, whereby the precipitate precipitates from the precipitation solution, and a reduced CO₂ gas is provided.

7. The method of claim 6 further comprising:
adjusting a pH of the precipitation solution to a pH at which the precipitate precipitates.

8. The method of claim 1, wherein the gas comprising CO₂ comprises a produced gas from the or another well, a flare gas, air, a flue gas, an exhaust gas, or a combination thereof.

9. The method of claim 8, wherein the gas comprising CO₂ comprises atmospheric air.

10. The method of claim 1, wherein the solution further comprises a substrate, and wherein precipitating the precipitate comprises precipitating at least a fraction of the precipitate onto the substrate.

11. A system comprising:
a precipitation apparatus configured for contacting a solution comprising one or more divalent cations with a gas comprising carbon dioxide (CO₂) to produce a precipitation solution from which a precipitate precipitates, wherein the precipitate comprises a carbonate of each of the one or more divalent cations; and
a pumping apparatus operable to pump at least a portion of the precipitate downhole via a well, whereby the at least the portion of the precipitate is stored downhole.

12. The system of claim 11, wherein the one or more divalent cations comprise calcium (Ca²⁺), magnesium (Mg²⁺), or both Ca²⁺, and Mg²⁺, respectively, and wherein the precipitate comprises calcium carbonate (CaCO₃), magnesium carbonate (MgCO₃), or both CaCO₃ and MgCO₃, respectively.

13. The system of claim 11 further comprising:
a separator configured to separate the at least the portion of the precipitate from the precipitation solution;
a mixing apparatus configured to produce a slurry comprising the at least the portion of the precipitate; or
both the separator and the mixing apparatus.

14. The system of claim 13, wherein the separator comprises a centrifuge, a settler, a decanter, or a combination thereof, and/or, wherein the precipitation apparatus comprises an absorber, a bubbler, a sparger, or a combination thereof.

15. The system of claim 11, wherein the gas comprising CO₂ comprises a produced gas, a flare gas, air, a flue gas, an exhaust gas, or a combination thereof, from the or another well.

16. The system of claim 15, wherein the gas comprising CO₂ comprises atmospheric air.

17. The system of claim 11, wherein the solution comprises a brine.

18. A method of sequestering carbon dioxide (CO₂), the method comprising:
forming a precipitate comprising one or more divalent cation carbonates by contacting a solution comprising a divalent cation of each of the one or more divalent cation carbonates with a gas comprising CO₂; and
introducing at least a portion of the precipitate into a reservoir by pumping a slurry comprising the at least the portion of the precipitate downhole into the reservoir via a well.

19. The method of claim 18, wherein the gas comprising CO₂ comprises, consists essentially of, or consists of air.

20. The method of claim 19, wherein the air comprises atmospheric air.
